(19) United States
(12) Patent Application Publication
(10) Pub. No.: US 2016/0047160 A1
(43) Pub. Date: Feb. 18, 2016

(54) ENCLOSURE ACCESS APPARATUS AND METHOD

(71) Applicant: Nam Duc HUYNH, Sudbury (CA)

(72) Inventor: Nam Duc HUYNH, Sudbury (CA)

(21) Appl. No.: 14/192,590

(22) Filed: Feb. 27, 2014

Related U.S. Application Data
(60) Provisional application No. 61/770,296, filed on Feb. 27, 2013.

(51) Int. Cl. E05F 15/77; A47B 88/04; E05F 13/00; E05F 11/00; E05F 15/603; E05F 15/74

(52) U.S. Cl. CPC E05F 15/77; E05F 15/603; E05F 15/74; E05F 13/00; E05F 11/00; A47B 88/0414; E05F 2015/763

(57) ABSTRACT

Automatic Kitchen Cabinet openers may frequently include two types of mechanisms. One type of mechanism is designed for a swinging door, such as a cupboard door. Another type is designed for sliding drawers. For a swinging door mechanism, a rotational motion is generated by a bi-directional servo motor to open or close, or open and close, the door. On a sliding mechanism, rotational motion of a geared motor may be converted to translational motion to slide the drawer in or out. These motors are controlled by a microcontroller as one system or individual unit with IR motion sensor integration or remotely via Wi-Fi or Bluetooth or voice control. In some embodiments the mechanisms may be operated by 6V or 12V DC battery adapter.

This application claims the benefit of the priority of U.S. provisional patent application U.S. Ser. No. 61/770,296 filed Feb. 27, 2013, the specification and drawings of which are hereby incorporated herein by reference.

### FIELD OF INVENTION

This apparatus and method herein pertain to enclosures and access to enclosures.

### BACKGROUND OF THE INVENTION

The opening and closing of enclosures spaces may be difficult for persons of limited mobility or physical strength. In such circumstances, or in circumstances where the person wishing access is inhibited from opening an enclosure, or is only able gently to touch the enclosure rather than to apply force to control opening and closing, it may be helpful to have a more automated approach.

### SUMMARY OF INVENTION

The following summary may introduce the reader to the more detailed discussion to follow. The summary is not intended to, and does not, limit or define the claims.

In an aspect of the invention there is an enclosure access apparatus mountable to drive a movable enclosure member relative to a stationary enclosure member. The apparatus has at least one fitting by which manually to move the movable enclosure member relative to the stationary enclosure member. An automated drive transmission also connected to move the movable enclosure member relative to the stationary enclosure member. There is at least a first user input, that first input being user-activated. The drive transmission being connected to operate upon receipt of a signal from said first input; said drive transmission has a first mode of operation to urge said movable enclosure member to move along a path of reciprocation relative to the stationary enclosure member. The drive transmission has a second mode of operation to urge said movable enclosure member to return along said path of reciprocation relative to the stationary enclosure member. The drive transmission has a disengaged mode when not activated. In said disengaged mode said drive transmission remains passive when the movable enclosure member is moved manually by said at least one fitting.

In a feature of that aspect of the invention the apparatus includes a manual over-ride, and, in a condition of manual over-ride, the automated drive transmission has a self-disengagement mode. In another feature the apparatus includes a touchless actuation sensor. In a further feature the touchless actuation sensor includes at least one of (a) a capacitance sensor; (b) an optical sensor; and (c) a voice-activated sensor. In yet another feature the has includes a plurality of touchless actuation sensors, and the apparatus operates in response to actuation of any one of the touchless sensors. In an additional feature the apparatus has at least one said touchless sensor and at least one contact operated input. In yet another additional feature at least one contact-operated input includes at least one of (a) a push button; (b) a wall switch; and (c) a treadle.

In another feature the apparatus includes a four-bar linkage. In an additional feature the drive transmission is self-disengageably connected to move said four bar linkage.

In another feature, the movable enclosure member is a hingedly mounted door, and the apparatus includes a motor and a drive link. The drive link is formed to have an accommodation therein. In at least one position of the apparatus said drive link nests about said motor. In an additional feature the motor is a DC one of a servo motor and a geared motor.

In another feature of that aspect, the movable enclosure member is a drawer, and said apparatus includes a timing belt drive operable to open and close the drawer. In still another feature, apparatus has a range of travel of the drive transmission. The range of travel has first and second ends, at least one of said first and second ends includes an “at rest” position. The disengaged mode includes the drive transmission being in one said “at rest” position.

In another feature, the apparatus is a hinged-door moving apparatus. The apparatus includes a pair of spaced apart plates co-operatively defining a circumferential arc about an axis of rotation of an output shaft driven by a motor. The transmission includes a driven link having a first end and a second end. The first end of the driven link is constrained to follow the circumferential arc. In at least one position, the hinged door driven link nests between the spaced apart plates, and the driven link has a bent shape to seat about the output shaft.

In a further feature, the drive transmission includes a motor-driven output arm and a driven link. The motor is drivable alternately clockwise and counterclockwise. The output arm is disengageable from said output link. The output arm engages a first portion of the driven link when the motor is operating to drive the movable enclosure member in a first direction, and said output arm engages a second portion of said driven link when said motor is operating to drive the movable enclosure member in a second direction opposite to the first direction. In an additional feature, one of the output arm and the driven member has a cam and the other has a cam follower, and one of the cam and the cam follower is displaceable against a bias to permit disengagement from the other.

In still yet another feature, the movable enclosure member is a drawer. The drive transmission includes a first member mounted to a motor-driven belt, and a second member mounted to the drawer. One of the first and second members is a lug. The other of the first and second members is a catch for mating operation with the lug. The catch includes a multi-armed pivotable anchor; the pivotable anchor is positioned to encounter, to be deflected, and to snag the lug during relative motion of the lug past the anchor. The apparatus includes at least one disengagement member positioned to encounter the anchor to release the anchor from said lug.

In still another feature, the apparatus is an automatic kitchen cabinet opener. The mechanisms can be grouped into one system to be controlled by a microcontroller with any one of IR motion sensors, touch sensors, voice control, a Human Machine Interface, staples, Ipad, Ipod, or other smart phone devices. In another feature, the apparatus is separated into individual standalone units with standalone controller boards and infrared motion/touch sensors. In a still further feature, the apparatus is provided as a retro-fit add-on kit for mounting to existing home kitchen cabinets/drawers as a hands-free mechanism permitting both automatic and manual operation modes.

In still yet another feature, the apparatus is mounted to at least one of (a) the stationary enclosure member; and (b) the movable enclosure member, exclusively by non-destructive attachment, where the non-destructive attachment may include at least one of (i) a bonding agent; (ii) an adhesive tape; and (iii) a glue. In another features, the apparatus includes a power source, and the power source includes a set of rechargeable batteries, those batteries having a voltage range of 3V DC to 15 V DC.

### BRIEF DESCRIPTION OF THE ILLUSTRATIONS

These and other features and aspects of the invention may be explained and understood with the aid of the accompanying illustrations, in which:

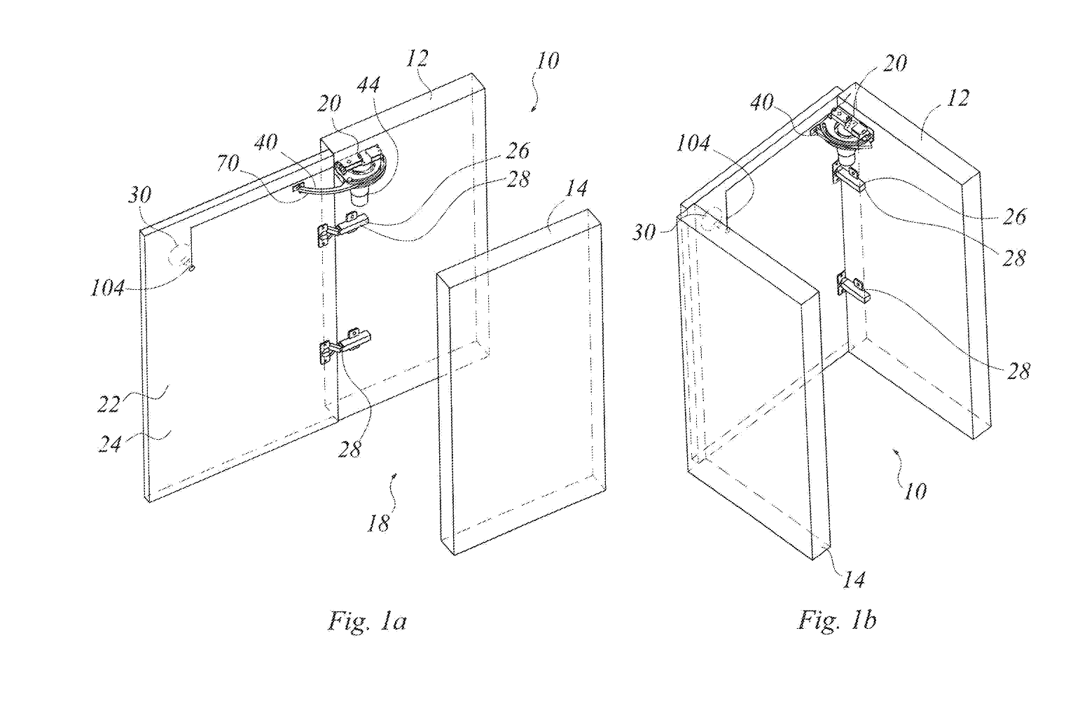

FIG. 1a is a general arrangement perspective view of a door assembly in an open position;

FIG. 1b is a general arrangement perspective vie of the door assembly of FIG. 1a in a closed position;

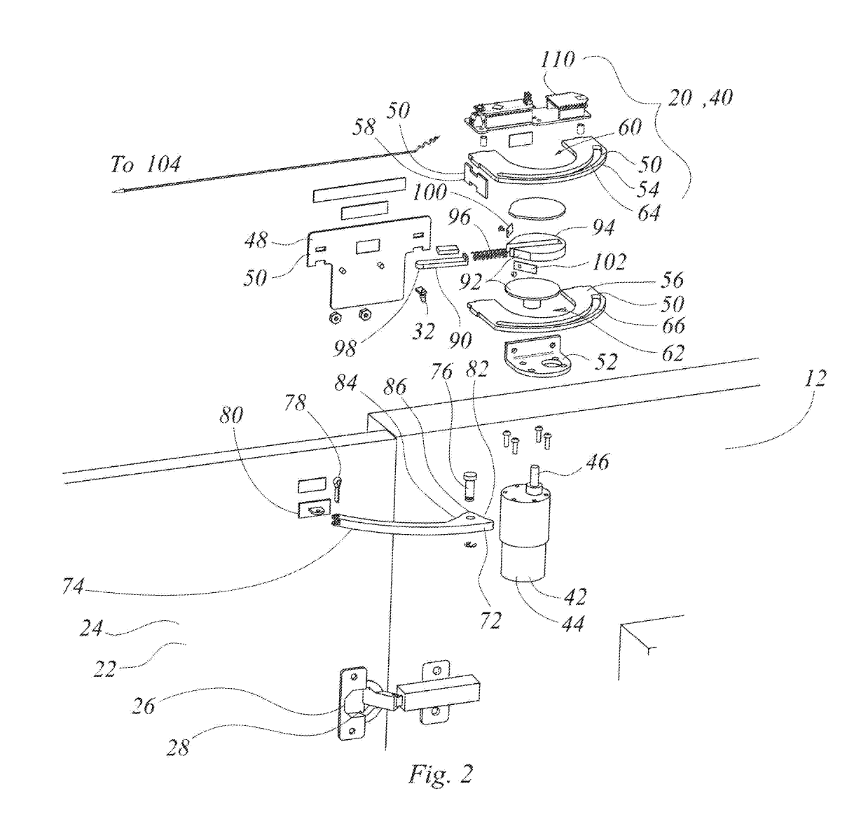

FIG. 2 is an exploded perspective view of a door drive assembly of FIG. 1a;

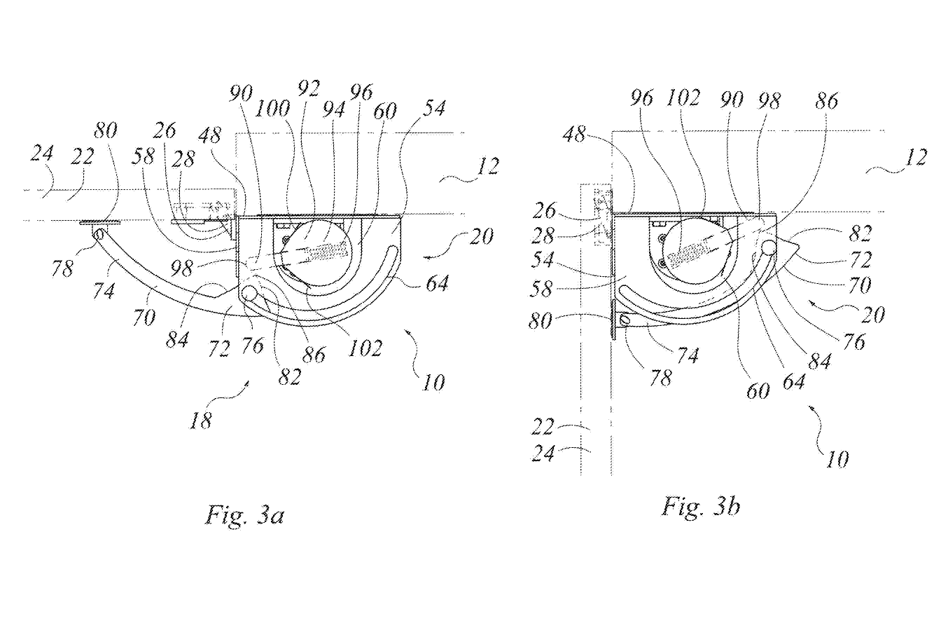

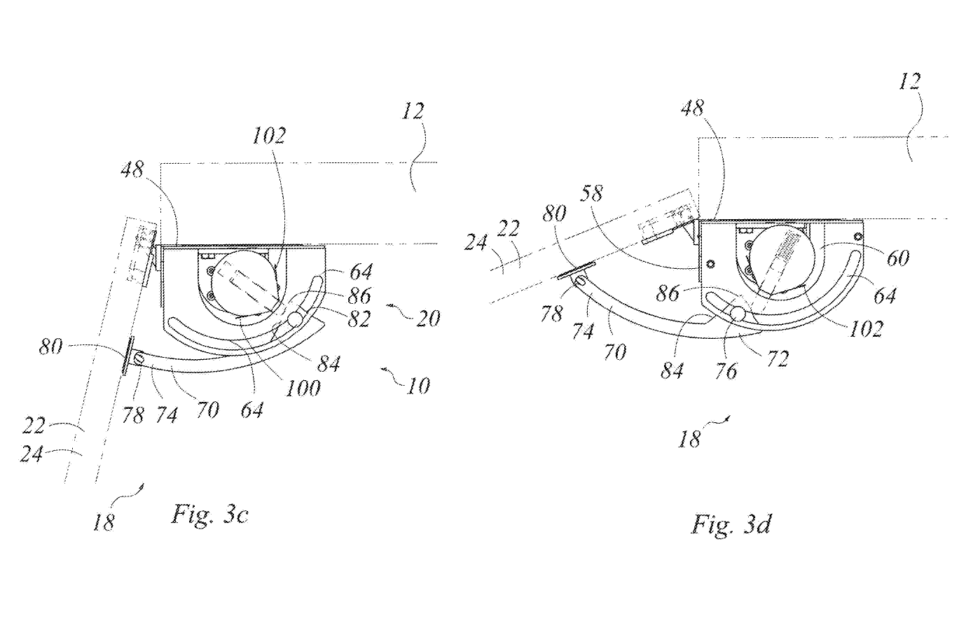

FIG. 3a is a top view of a door drive assembly of the door assembly of FIG. 1a in the open position with the door shown in phantom;

FIG. 3b is a top view of the door drive assembly of FIG. 3a in the closed position with the drive arm radially retracted to disengage the cam;

FIG. 3c is a top view of the door drive assembly of FIG. 3a in a partially closed position with the drive arm ready cam follower working along the cam prior to disengagement;

FIG. 3d is a top view of the door drive assembly of FIG. 3a in a partially open position with the drive arm working against the opening cam to drive the door from the closed position to the open position;

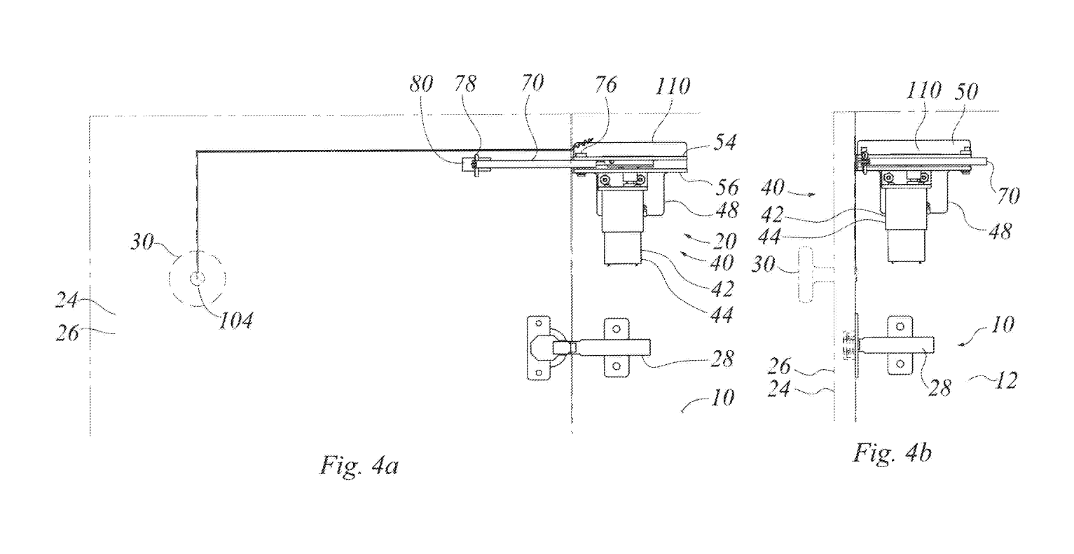

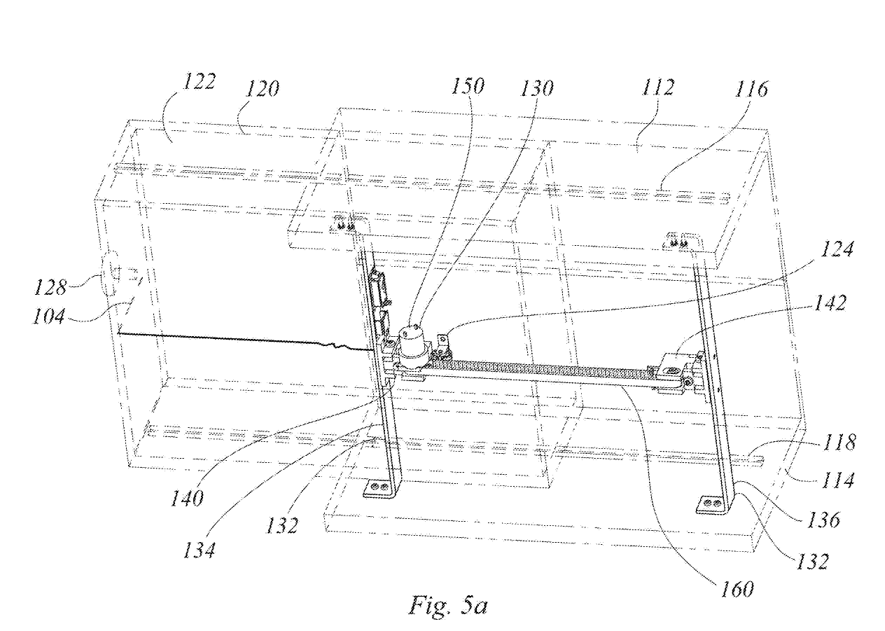

FIG. 4a is a side view of the door drive assembly of FIG. 3a in the open position;

FIG. 4b is a side view of the door drive assembly of FIG. 3a in the closed position;

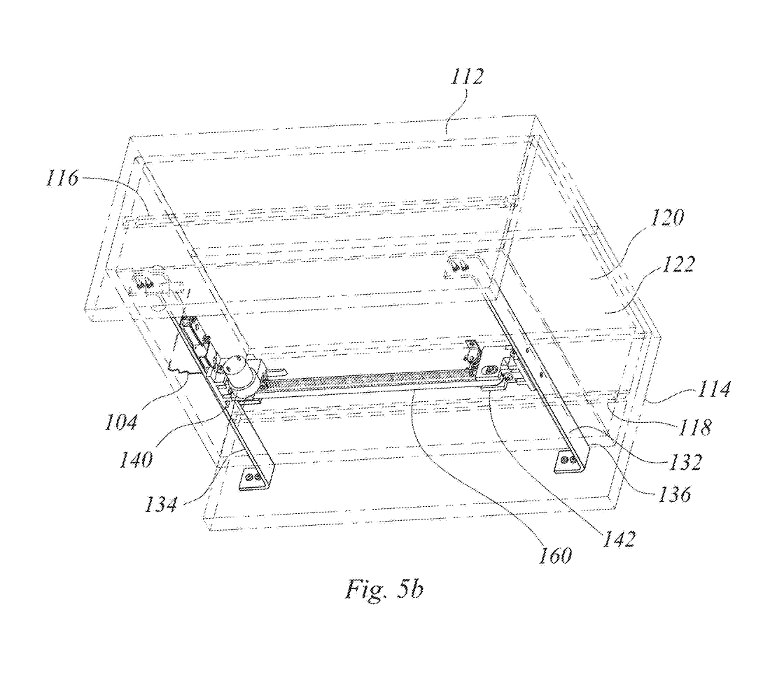

FIG. 5a is a general arrangement perspective view of a drawer drive transmission assembly with the drawer shown in phantom, the drawer being in the open position;

FIG. 5b is a general arrangement perspective view of the drawer drive transmission assembly of FIG. 5a with the drawer in the closed position;

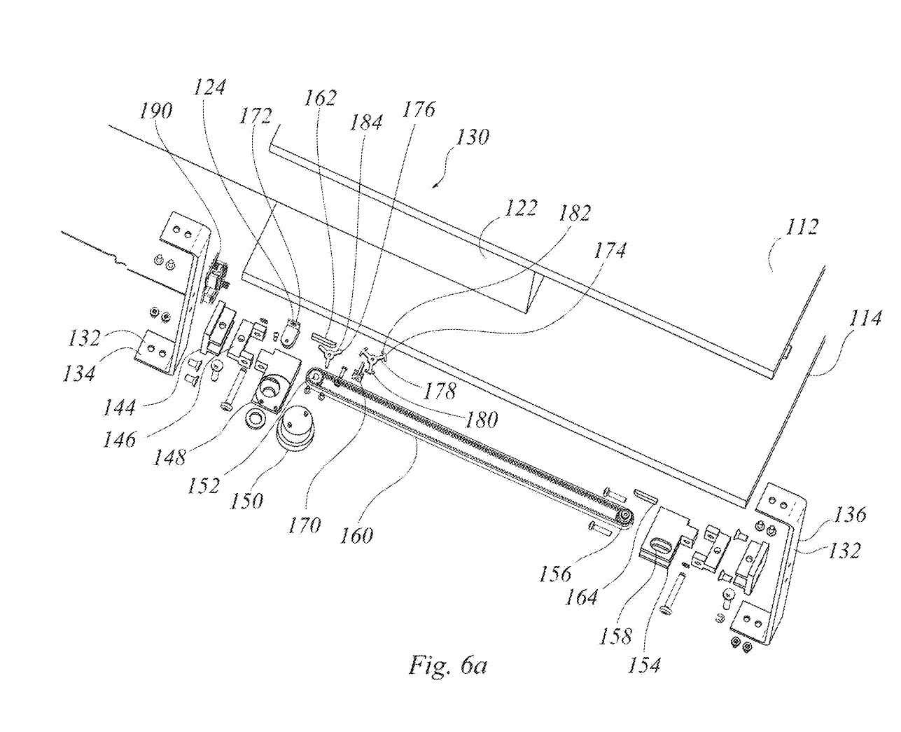

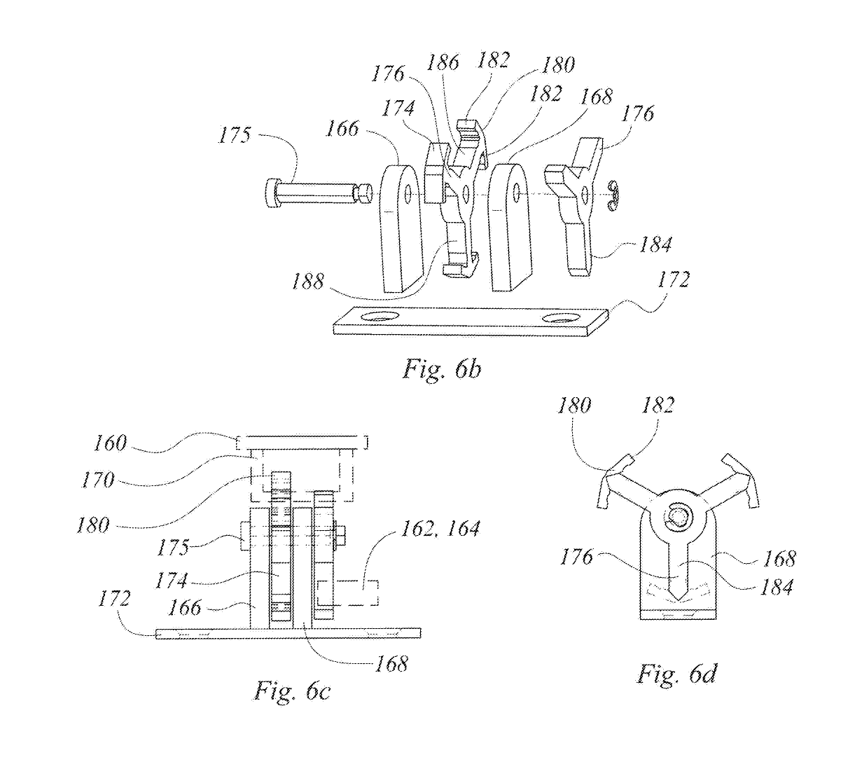

FIG. 6a is an exploded perspective view of the drive assembly of FIG. 5a;

FIG. 6b is an exploded perspective view of an enlarged detail of FIG. 5a showing a disengageable drive interface assembly;

FIG. 6c is an end view looking along a timing belt showing the relationship of the timing belt to the disengageable drive interface assembly of FIG. 6b;

FIG. 6d is a side view of the disengageable drive interface of FIG. 6b;

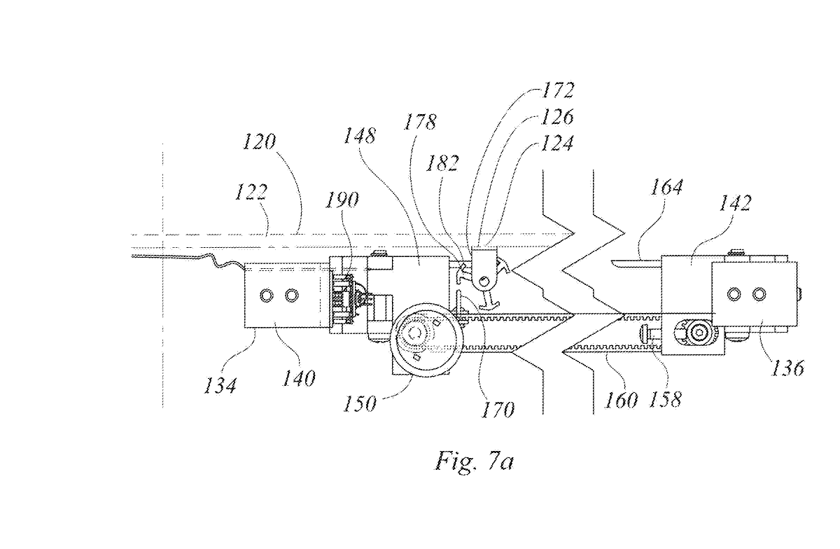

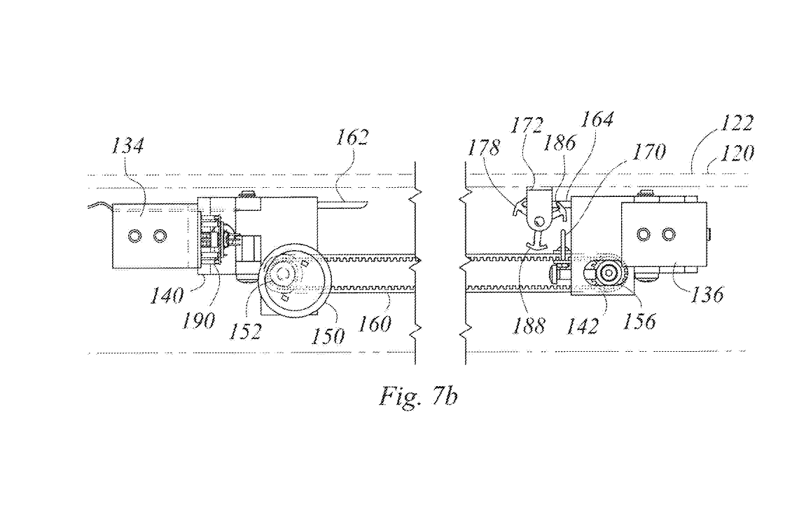

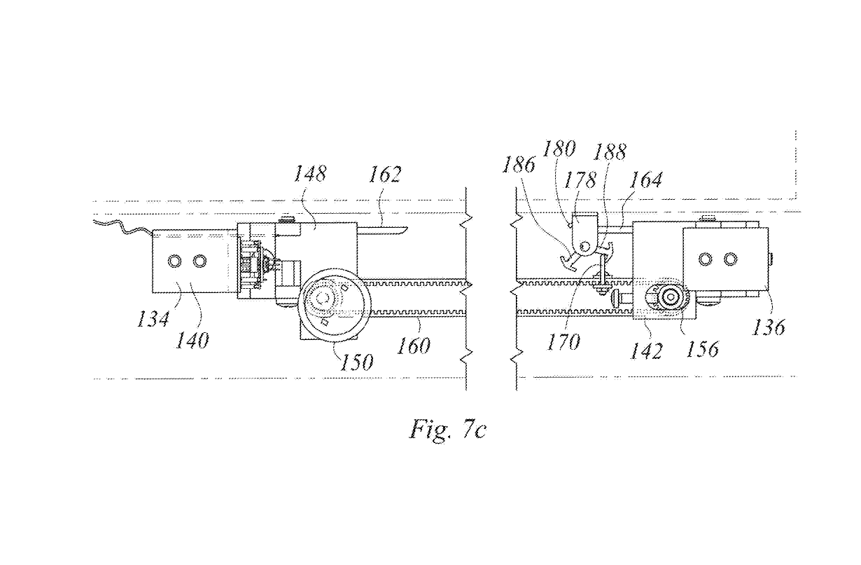

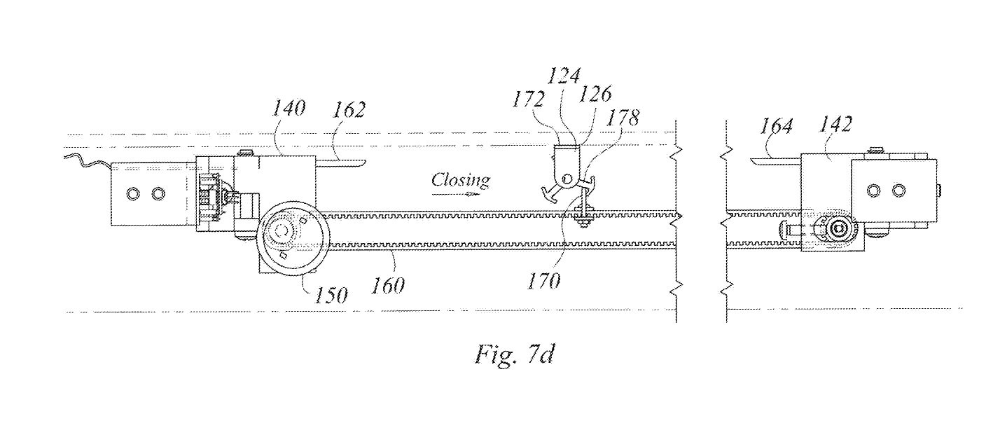

FIG. 7a is a side view of the drive transmission assembly of FIG. 5a with the drawer shown in phantom in the open position, the assembly being foreshortened for clarity by omission of the mid-portion of the drawer track at the section lines, as indicated;

FIG. 7b is a side view of the drive transmission assembly of FIG. 6a in the closed position;

FIG. 7c is a foreshortened side view of the drive transmission assembly of FIG. 6a in a nearly closed, disengaging position;

FIG. 7d is a side view of the drive transmission of FIG. 7a in midway closed position;

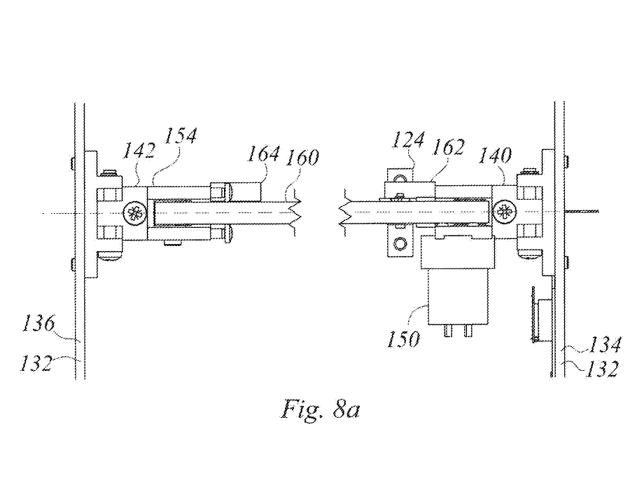

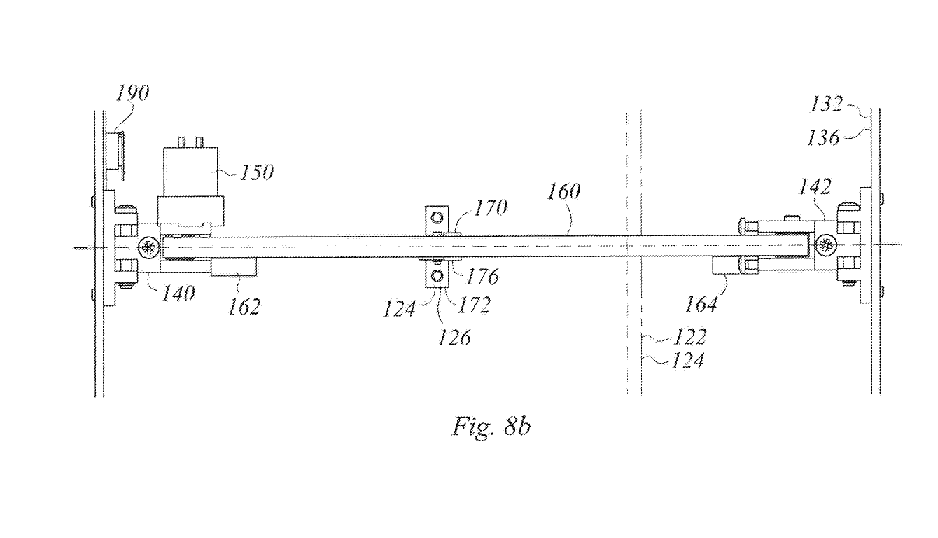

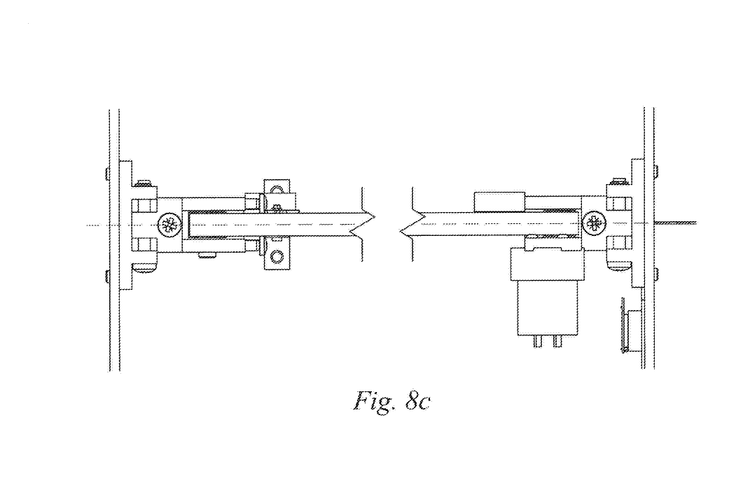

FIG. 8a is a bottom view of the apparatus of FIG. 7a in a fully open position;

FIG. 8b is a bottom view of the apparatus of FIG. 8a in a midway closed position;

FIG. 8c is a bottom view of the apparatus of FIG. 8a in a fully closed position; and

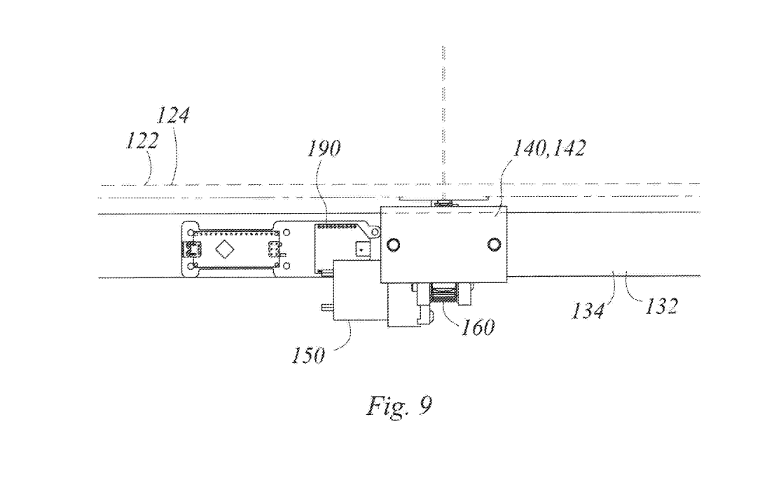

FIG. 9 is an end view of the apparatus of FIG. 7a, looking forwardly.

### DETAILED DESCRIPTION

The description that follows, and the embodiments described therein, are provided by way of illustration of an example, or examples, of particular embodiments incorporating one or more of the principles, aspects and features of the present invention. These examples are provided for the purposes of explanation, and not of limitation, of those principles, aspects and features of the invention. In the description, like parts are marked throughout the specification and the drawings with the same respective reference numerals. The drawings may be taken as being to scale, or generally proportionate, unless indicated otherwise.

The scope of the invention herein is defined by the claims. Though the claims are supported by the description, they are not limited to any particular example or embodiment, and any claim may encompass processes or apparatus other than the specific examples described below. Other than as indicated in the claims themselves, the claims are not limited to apparatus or processes having all of the features of any one apparatus or process described below, or to features common to multiple or all of the apparatus described below. It is possible that an apparatus, feature, or process described below is not an embodiment of any claimed invention.

The terminology used in this specification is thought to be consistent with the customary and ordinary meanings of those terms as they would be understood by a person of ordinary skill in the art in North America. The Applicants expressly exclude all interpretations that are inconsistent with this specification, and, in particular, expressly exclude any interpretation of the claims or the language used in this specification such as may be made in the USPTO, or in any other Patent Office, other than those interpretations for which express support can be demonstrated in this specification or in objective evidence of record, demonstrating how the terms are used and understood by persons of ordinary skill in the art, or by way of expert evidence of a person or persons of experience in the art.

This description discusses enclosure opening and closing assemblies and elements of such assemblies. In this discussion, in the context of opening and closing assemblies that move a door that swings on hinges, it may be helpful to make reference to a polar cylindrical co-ordinate system in which elements have a center of rotation in which the axis of rotation is typically vertical and is typically designated as the x-axis or z-axis or axial direction. In such systems the distance away from the axis of rotation is generally considered the r, or radial, direction; and motion about the axis is considered to be arcuate or circumferential, and may involve position, typically designated by an angle θ, motion having angular velocity, typically indicated by ω, or an angular acceleration indicated by α. Alternatively, in the case of an opening or closing assembly for linear translation, it may be helpful to refer to a Cartesian co-ordinate system. In the embodiments described, the x-axis or x-direction may be taken as being the length or lenghth-wise direction of the eventual assembly as assembled and installed. In such installation the x-direction would most normally be a horizontal axis in the direction of reciprocating linear translation of the assembly. The y-direction may be taken as the horizontal direction running along the wall width-wise, that is, a horizontal axis perpendicular to the direction of linear translation. In the description, the major faces of the modular wall panels tend to be planar surfaces extending heighth-wise and width-wise in an x-y plane. The z-direction may be taken as the vertical through-thickness direction, or depth, of the enclosure. This co-ordinate system assumes that the wall or wall module, or components thereof, is or are, viewed as finally installed. The terminology is nonetheless somewhat arbitrary and is understood whether the unit is installed in a vertical orientation, or is being processed in a factory in a horizontal or other orientation. The commonly used engineering terms “proud”, “flush” and “shy” may be used herein to denote items that, respectively, protrude beyond an adjacent element, are level with an adjacent element, or do not extend as far as an adjacent element, the terms corresponding conceptually to the conditions of “greater than”, “equal to” and “less than”.

In this description, without limiting the generality of the narrative, there are two disclosed embodiments. In a first embodiment, such as shown in FIGS. 1a to 4b there is a an access governing apparatus 20 for a door assembly 22 that moves arcuately, that is, the motion of the door is not merely of linear translation but may include, or may be entirely, an angular motion. The motion is a reciprocating motion, and, in the embodiment shown, is an angularly reciprocating motion about hinges. In the embodiment of FIGS. 5a to 9 there is an access opening operation assembly that has a linear motion embodiment. That is, in the embodiment of FIG. 9 the apparatus may pertain to a drawer, or to a linearly sliding access door. These devices are intended to open or close the door or drawer, as may be, automatically by actuators.

In FIG. 1, the mechanism is used to open swing doors which may be, for example, kitchen cabinet doors. In FIG. 2, the sliding mechanism may be used for kitchen cabinet drawers, or other drawers. However, both mechanisms could be used on similar application such as dresser drawers, etc. Each of the mechanisms has a motor to generate the force or torque required. The motors may be directly connected to a power source, such as 110 VAC 60 Hz., or to a power supply that has a reserve, such as a battery. The motor may, for example, be a 6V/12V dc motor.

Considering first the embodiment of FIG. 1a, an enclosure, or chamber, such as a cupboard or closet is shown in phantom lines and indicated generally as 10. Enclosure 10 has bounding left-hand and right-hand sidewalls 12, 14, and may have a floor and roof or ceiling. However it may be, enclosure 10 has an opening 18 through which objects may be introduced or retrieved, and door assembly 22 is mounted to govern access to the chamber defined inside enclosure 10.

Door assembly 22 may include a movable door panel, 24, and mounting fittings 26 by which door panel 24 is secured to the adjacent stationary structure. Mounting fittings 26 may be hinges, such as shown at 28. Door assembly 22 is movable between a first position, as indicated in FIG. 1b, which may be a closed or obstructed position in which door panel 24 is located athwart opening 18, and may tend thereby to block or otherwise impede or obstruct access to the internal chamber of enclosure 10, and a second position, as indicated in FIG. 1a, in which door panel is moved to an open position less obstructive of opening 18. Control of door assembly 22, and motion of door assembly 22 thus governs access to enclosure 10.

Door assembly 22 may include an handle or hand grip 30, or other similar means by which a person may open and close door panel 24 manually in the customary manner. Grip 30 may be considered a manual user interface. When door assembly 22 is open, the interior of enclosure 10 may be illuminated by an LED 32 that operates in response to door position. Door assembly 22 may also include a drive, or transmission assembly, generally indicated as 40.

Transmission assembly 40 may include an actuator 42, which may have the form of an electric motor 44. Motor 44 may be a DC servo motor with a geared output shaft 46. Motor 44 may be mounted to a base plate or mounting plate, or fitting 48, that fitting itself being mounted to either stationary structure, such as wall 12, or moving structure such as door panel 24.

Fitting 48 may define an armature, or frame or motor assembly housing or body, indicated generally as 50. Body 50 may include main mounting plate 48, an L-shaped motor bracket 52, a top plate 54, a bottom plate 56, and an end face plate 58. Top plate 54 and bottom plate 56 have toes keyed to pick up on apertures formed in base plate fitting 48, and, similarly, plates 54, 56 and 58 are slotted to fit together to form a square sided interlocking frame in which plates 54 and 56 lie in spaced apart, parallel x-y planes. End face plate 58 stands in a z-y vertical plane which may be flush, or perhaps shy, of the vertical plane of the inside face of door panel 22 when door panel 22 is closed. The U-shaped, or C-shaped form of plates 54, 56 and 58 mounts to, and stands outwardly proud away from the inside wall face of wall panel 12. The various plates may be made out of stamped sheet metal, be it mild steel of aluminum. Alternatively, in the parts may be made of plastic where, for example, lightness of weight or low manufacturing cost may be desired.

Each of top plate 54 and bottom plate 56 has an opening, or allowance, or rebate, or relief, or accommodation formed therein as indicated at 60, 62, such as may surround the output drive of motor 44. Each of top plate 54 and bottom plate 56 may also have formed therein corresponding upper and lower guides or guideways, or tracks, or cams, or retainer paths, 64, 66, however they may be called, by which to guide a pin or roller mechanism, as described below.

A driven link is indicated as 70. Driven link 70 has a first end 72 and a second end 74. First end 72 is pivotally anchored to a lever pin 76 that engages, is retained within, and has a degree of freedom of motion restrained to run along, the pathways defined by upper and lower retainer paths 64 and 66 of top and bottom plates 54, 56, respectively. Second end 74 is pivotally anchored at a pin connection 78 mounted to a foot, or wall fitting 80 mounted to the inside face of door panel 24. As may be appreciated, it is somewhat arbitrary whether main wall fitting 48 is mounted to stationary structure, such as wall panel 12, and wall fitting 80 is mounted to moving structure such as door panel 24, or vice versa. These fittings can be mounted to the adjacent structure by mechanical fasteners such as screws, or by adhesive pads, as may be appropriate. Use of an adhesive pad, or tape, or double-sided tape, or glue, may be suitable in retro-fit installation, or in installations where it may be desired subsequently to remove the drive assembly without having done permanent damage to the underlying structure. At the first, or input drive end of driven link 70 there is a predominantly triangular bulge. That bulge has first and second cam surfaces 82, 84, which meet at an apex 86. The purpose and operation of these cam surfaces will be described below. As can be understood, driven link 70 is captured between, or sandwiched between, the top and bottom plates 56, 58, and lever pin 76 is in double shear with a force, perhaps an approximately equally balanced for, applied above and below to each end. It may also be noted that driven link 70 has a generally curved, or dog-legged, or arcuate body 88, which may be formed on a generally circular arc. The inside face of arcuate body 88 is formed to clear the drive cap of the motor output, and, in the closed position, to hook around it in a compact assembly, as perhaps best seen in the closed position shown in FIG. 3b.

A motor output arm is indicated as 90. An output head, or crank, or motor output interface assembly 92 is mounted to output shaft 46 of motor 44, and is rotationally driven thereby, clockwise or counter-clockwise as may be. Assembly 92 includes a seat 94 for the radially proximate end of arm 90. Seat 94 may have the form of a radial slot, as indicated. Arm 90 itself is L-shaped, with the short foot of the L being radially inward, and mounted against a biasing member which may be in the nature of a spring 96 that radially biases arm 90 to the radially most-extended position, while permitting a radial range of travel. A stop is mounted radially outboard of the foot or arm 90, thus capturing arm 90 and defining the outermost stop of its range of motion. The radially distal extremity of arm 90, may be identified as the tip or as a cam follower 98. Output interface assembly 92 also includes forward and reverse travel limit switch contacts 100, 102 such as may cause motor 44 to stop turning when arm 90 reaches its clockwise and counter-clockwise end of travel limits.

As may be understood, the fixed structure may define a first bar of a four bar linkage. The combined effect of top and bottom plates 56, 58 and their guide paths is to define a second bar. Driven link 70 defines a third bar. Door panel 24 defines the fourth bar of the four bar linkage. The drive train defined by the door drive or transmission 40 defines an actuator assembly mounted to drive the four-bar linkage between the first and second positions associated with, or defining, the closed and open positions of the door more generally.

A sensor, or sensors, 104, is mounted to door panel 24, or at some nearby location, such as may be visible or otherwise known to such persons as may wish to obtain access to enclosure 10. Sensor 104 may be a push button, or floor plate, or treadle, or handle, or wall switch, or perhaps more than one of them mounted electrically or pneumatically in parallel. Sensor 104 may also be a non-touch sensor such as may be a capacitance based sensor activated by a change in the proximate capacitance, as when a hand passes close to, or touches, the sensor. Sensor 104 may be an optical sensor. Although different embodiment and combinations of embodiments are possible, in one particular embodiment sensor 104 is a capacitance sensor. That is, in one embodiment, sensor 104 is mounted to door panel 24, and is capacitively sensitive to the presence or absence of a hand (or other object) passing closely adjacent thereto such that merely touching the sensor, or touching the door closely adjacent to the sensor may cause the drive assembly to actuate. In another embodiment, sensor 104 is a sound or voice activated sensor. In another embodiment, sensor 104 represents both voice and capacitance activated sensors, such as may operate in parallel. Sensor 104 may be, or may include, a motion sensor or infra-red sensor. Although an assumption of this description is that the desirability of the apparatus described herein is related to limitations of strength or mobility, it may also be that a non-touch opening system may be desired where the user's hands are encumbered, or unclean (as in a garage), or unsanitary (as in a medical facility or clinic), or oily or greasy (as when working in the kitchen, and needing to pick up recipes or to obtain cookware from a cupboard or drawer. In any case, sensor 104 defines a user operated input to the automated drive transmission system. Sensor 104 may be mounted at, or adjacent to handle or hand grip 30, and, where, for example, sensor 104 is, or includes, a capacitance sensor, sensor 104 may be tripped or activated when handle or hand grip 30 is held by a user. Of course, sensor 104 may also be mounted remotely from sensor grip 30, such that one may be operated without engaging the other. Sensor 104 may function as a user input interface, but it need not be a manual user input interface.

Electrical circuitry such as a computer processor board, or controller, 110 is mounted to body 50. Whether battery powered, or powered from a line source through a transformer and rectifier, or otherwise, processor board 110 is connected by appropriate apparatus to monitor the state of sensor 104 (or the state of such array of multiple sensors as may be represented by sensor 104). That connection apparatus may include a wiring or wireless connection, as may be suitable. For example, the apparatus may be operated by Bluetooth™, and may be linked thereby, or otherwise, to a user's Ipad, Iphone, android, or smartphone device.

Assuming door panel 24 to be closed, as shown in FIG. 1b, and in FIG. 3b, it may be that a person desiring access to enclosure 10 approaches enclosure 10 and trips or activates sensor 104. The controller senses (or knows from memory) that arm 90 is in the closed, inactive, position. Controller 110 then causes motor 44 to turn, driving arm 90 in the clockwise direction. To the extent not before done, this turning motion of arm 90 urges tip 98 into contact with, and biases it against, first cam surface 82 of driven link 70. A force is then exerted through cam follower 98 against first cam surface 82, a component of that force tending to drive lever pin 76 along the trackway defined by the matched upper and lower retainer paths 64, 66, which happen to be circumferentially extending paths relative to the center of rotation of arm 90. The component of force transmitted along the line of axes of the pins at the pin-jointed ends of driven link 70 imposes a force on door panel 24 at fitting 80, resulting in a moment couple on door panel 24 about its hinges, that moment couple tending to cause door panel 24 to open. This may correspond to FIG. 3d.

This process will continue until lever pin 76 reaches its end-of-travel stop at the clockwise end of the track defined by upper and lower retainer paths 64, 66. At that point lever pin can move no farther. However motor 44 continues to drive arm 90, with the result that cam follower 98 continues to run along first cam surface 82 toward, and past, apex 86, such that arm 90 compresses spring 96 thus moving the tip, cam follower 98 to a radially retracted position, permitting cam follower 98 to disengage from first cam surface 82, to run over apex 86, and to allow arm 90 to turn beyond it. After follower 98 has passed apex 86, the limit switch contacts close at the clockwise end limit switch contact 100. When the switch trips, the controller processor shuts of the power to motor 44, and sets the memory to reverse the direction of the motor the next time the motor is operated. This is the status shown in FIG. 3a.

Alternatively, when it is time to close the door, if sensor 104 is activated motor 44 will again be turned on by the processor, this time running in the opposite direction to bring cam follower 98 into contact with second cam surface 84 to urge door panel 24 in the counter-clockwise direction toward the closed position. Once again, however, lever pin 76 reaches its end of travel before motor 44 stops running. The clockwise end of travel may be dictated by the door sill. That is, whether lever pin 76 reaches the counter-clockwise end of the track or slot defined by retainer paths 64, 66 or not, when panel 24 encounters the door sill or door jamb, the reaction prevents door panel 24, and hence driven link 70, from moving any further. As when running in the other direction, motor 44 continues to run, forcing cam follower 98 to ride up along second cam surface 84, thereby depressing spring 96, and, eventually, driving cam follower 98 past apex 86. After turning beyond apex 86, the spring pushes the radial arm back out to its fully extended position, and arm 90 continues turning until the counter-clockwise limit switch contacts 102 are closed. When contacts 102 are closed, the controller turns power off, and resets the latch or memory to the opposite direction so that the next time motor 44 is actuated, it will turn in the opposite direction, i.e., clockwise as illustrated.

In this embodiment, there may also be a door position sensor by which the processor may determine if door panel 24 is in the fully closed position of FIG. 3d; the fully open position of FIG. 3a, or neither.

In operation, if the actuator assembly, i.e., the automated door drive or transmission, is not actuated, the door may be operated as a manual door in the customary manner. Further, if someone is holding the door by force, or if the door is blocked, the cam follower will ride over apex 86, and continue until it reaches end of travel, where it will turn itself off. If it should happen that the door panel 24 has been forcefully closed during an opening duty cycle of motor 44, motor 44 will continue to run until the clockwise limit switch 100 is tripped, and then it will shut off in the “away” position of arm 90 shown in FIG. 3a. The next time sensor 104 is activated, motor 44 will run to the “home” position of arm 90, shown in FIG. 3b. On the way to the “home” position, cam follower 98 will be driven past apex 86, no matter what the then position of door panel 24 may have been. A further activation of motor 44 will then open door panel 24.

Alternatively, if door panel 24 is closing, and someone chooses manually to over-ride motor 44, cam follower 98 will run over apex 86, and motor 44 will run to the “home” position, and stop there. In this condition the door is left manually open, as may have been desired by the person using the door. Thus door panel 24 may be operated manually, or automatically, and while motor 44 may help someone of limited strength or mobility, it may also be over-ridden, or the door may be used without operation of motor 44 at all. In the event that motor 44 should fail, or in the event that motor 44 is run on batteries, and those batteries lack charge, door panel 24 may still be opened and closed manually. This may be a consideration of importance where enclosure 10 is used as a storage location for medication, and it is desirable that it be possible to open door panel 24 whether the automatic system is operational or not. That is, it may be desirable to have a fail safe system that permits door panel 24 to be opened manually if need be.

The embodiment of FIGS. 5a-9 shows a linearly reciprocating enclosure assembly 120, which may have the form of a reciprocally movable shelf or tray or drawer 122. Drawer 122 is movable in axial translation in the x-direction, and is carried on, in, or between stationary structure, such as may be represented in phantom in FIGS. 5a and 5b as left and right hand side-walls 112, 114, the motion being governed or guided by a path or track or guides defined by on rails or slides 116, 118 as may be customary.

Drawer 122 may also be provided with a drive input interface, or drive input interface fitting, which may be termed an anchor, a bracket, a lug, and is shown representatively as interface fitting 124. In this instance interface fitting 124 is rigidly mounted to drawer 124, and had the form of a bracket 126 mounted to the underside thereof. For symmetrical distribution of forces it may be convenient if bracket 126 is mounted along the center line of drawer 122 i.e., centered on the central vertical plane of symmetry of drawer 122. Drawer 122 also has a drawer pull, or handle, or grip, indicated generally as 128. The handle may be considered to be a manual user interface.

A reciprocating transmission or drive assembly is indicated generally as 130. Assembly 130 has a body or frame or array of frames or structural members 132 mounted to a common structural datum. In the embodiment shown, assembly 130 is mounted to stationary structure, and interface fitting 124 is mounted to moving structure. Although it may be considered desirable for the assembly of greater weight to be mounted to the stator or stationary structure, this choice is somewhat arbitrary: the anchor, bracket 126, could be mounted to stationary structure while drive assembly 130 is mounted to moving structure. This discussion proceeds on the basis of mounting the drive assembly to stationary structure.

In this discussion, forward, or forwardly, pertain to the direction the drawer is pulled in which to move it to, or to cause it to be open. Rearward is the opposite, closing, or closed direction. In the embodiment shown, the supporting structure includes a first, or forward, frame or brace, or support 134, and a second, or rearward, frame or brace or support 136. Each of supports 134 and 136 spans the space between stationary walls 112, 114. It is not necessary that supports 134 and 136 span the space, they could be mounted to a single wall. In any event, they are rigidly fixed in position to a common datum (112, or 114, as may be).

A first or head assembly 140 of drive assembly 130 is mounted at mid-span to support 134, and a second, or tail, assembly 142 is mounted to support 136. The choice is arbitrary, and could be reversed.

Head assembly 140 has a main mounting bracket 144 which mounts rigidly, and typically centrally, to first support 134. Bracket 144 defines a channel or clevis, having a bore to accept a laterally driven pin or bolt that passes through the back of a yoke 146 to which a motor base or housing 148 is pivotally mounted on a vertically extending bolt. The us of the lateral and vertical bolts permits the assembly to be adjusted for vertical angle (pitch) and for lateral angle (yaw). In effect, items 146 and 148 define a universal joint.

Motor 150 is mounted to motor base 148. Motor 150 may be a servo motor, the same as, or similar to motor 44, and may be a bi-directional DC motor. Motor 150 may be mounted transversely with its axis of rotation oriented in the y-direction. Motor base 148 may be a gear box with internal gearing, and an output shaft having an output gear, namely pinion 152, mounted thereto.

Tail assembly 142 is substantially similar to head assembly 140, with universal joint components 144 and 146, but rather than having a motor and driven pinion, tail assembly 142 has an idler assembly 154 that includes idler 156 carried on bushings in assembly 154. A timing belt 160 is looped over pinion 152 and idler 156. The longitudinal position of idler 156 is adjustable with axial direction idler adjustment 158 to permit installation and to permit slack to be adjusted in timing belt 160.

Both head assembly 140 and tail assembly 142 are provided with a disengagement abutment member, those being the forward drive disengagement member, in the form of finger 162; and a rearward drive disengagement member, in the form of finger 164. An indexing member, or drive interface member, or drive transmission pick-up, or abutment, or bracket, or arm, or hook, or loop, or eye, or lug, or seat, however it may be called, is generally identified as item 170, and is fixedly mounted to that portion of timing belt 160 facing toward interface fitting 124, items 124 and 170 being formed for mating engagement and disengagement.

Interface fitting 124 has a U-shaped, or top-hat shaped bracket 172 that is mounted to the underside of drawer 122. Bracket 172 has a pair of spaced apart legs 166, 168. First and second pick up members 174 and 176 are carried on a common shaft or pin 175 that runs laterally between the eyes of the clevis defined by legs 166, 168 of bracket 172. First pick up member 174 is mounted in double between legs 166, 168, and second pick-up member 176 is mounted outboard of leg 168. Pin 175 is a torque-transmitting pin. That is, pin 175 is keyed, or splined to mate with correspondingly keyed or splined apertures in members 174, 176 such that members 174 and 176 are constrained to turn together, such that torque imparted to member 176 will tend to rotate member 174.

Member 172 has three arms 178, on 120 degree circumferential spacing. Each arm terminates radially outwardly with a transmission interface engagement member such as may be in the nature of a two-ended, or two-toothed foot or hook, or catch, 180, the individual teeth thereof being indicated as 182. Member 172 is positioned such that in any orientation, one arm 178 or another will hang sufficiently far downward to encounter drive interface member 170. At the same time, the distal tip of drive interface member 170 is short enough that it clears the central axis of the pin to which members 174 and 176 are mounted. Member 174 also has three arms identified as 184, and is positioned so that those three arms 184 line up with the three arms of member 174. However, the arms 184 of member 176 are positioned with respect to the y-axis such that one of them will encounter fingers 162 and 164, as shown in FIG. 6c.

As before, the assembly includes a sensor 104, which may be of the type or types mentioned above, appropriate wired or wireless connections, and a processor 190 mounted to forward support 134 that receives input signals from such sensors 104 as may be, and provides output signals to control operation of motor 150. There are, additionally, forward and rearward limit switches connected to, and driven by, fingers 162 and 164.

In operation, starting from the position shown in FIG. 6a, Finger 162 is engaging one arm 184 is encountered by finger 162, such that arm 184 and its mating arm 178 of member 174 are deflected to, roughly, a 1:30 o'clock position relative to the legs of bracket 172. The next most adjacent leg counter-clockwise, identified as 186 is then at 9:30 o'clock position, and the third leg, identified as 188, is located at 5:30. As such the teeth 182 of hook 180 of arm 186 is forced to a position disengaged from drive interface member 170.

In this position, a person may grasp door handle or grip 128, and may close drawer 122 by pushing it inward to its closed position. This action will drive interface fitting 124 rearwardly away from drive interface member 124. When the drawer seats in its closed position, finger 164 will engage the upwardly oriented arm 184, and push it to the 10:30 o'clock position seen in FIG. 6b.

If, alternatively, a person activates sensor 104, controller 190 will cause motor 150 to move belt 160 to drive interface member 170 forward (i.e., to the right in FIG. 6a), causing it to engage with the hook of the first arm it encounters, namely catch 180 of the downward-most arm 178. When so engaged, motor 150 will drive drawer 122 to the closed position. When it approaches that closed position, however, the uppermost arm 184 of member 176 will encounter finger 164 of the rearward disengagement abutment which forces first pick-up member 174 to rotate counter-clockwise, forcing catch 180 to disengage upwardly as it rotates from the seat of drive interface member 170, allowing drive interface member 170 to proceed until motor 150 stops at the end of travel limit when member 170 reaches the housing of idler assembly 154 of tail assembly 142. As this occurs, the controller also reverses the direction of motor 150.

When the next person comes to open drawer 122, they may do so manually, without altering the position of motor 150, timing belt 160, or drive transmission interface member 170. Alternatively though, they may activate sensor 104, causing the controller defined by processor 190 to drive timing belt 160 in the opposite direction, such that drive interface member moves leftward (as seen in FIG. 6b), thereby to encounter and engage the catch of the first arm it encounters, and, once so engaged, to urge drawer 122 to the open position.

In each mode, interface member engages one of the hooks, or catches, 180, is a pulling, or towing, mode. It may occur that while motor 150 is in operation, a user may manually force drawer 122 in the direction opposite to the direction in which motor 150 is working. When this occurs, the controller senses at least one of (a) an increase in motor current indicating that an obstruction has been encountered (b) a stopping or reversal of position. In either case, processor 190 stops the motion of motor 150. Where motor 150 continues to be forced in the opposite direction, processor 190 may re-start motor 150 to run in the direction conforming to the manual force being applied to drawer 122, and may continue to run until end of travel is reached in that direction, at which point the motor will be in the “at rest” position. Assembly 130 may then remain in that position until a new actuation signal is received. When that signal is received, assembly 130 will run in the direction away from its “at rest” position and, unless otherwise interrupted, will continue running until it reaches the “at rest” position at the far end of its travel. The relationship of items 170 and 172 is such that, in the normal course of running to full travel item 170 will encounter item 172, and move drawer 124 accordingly, even if drawer 124 has previously been left in a mid-way position by manual means.

Although the catching apparatus has been shown with three arms, it may be that a catching apparatus with a different number of arms might also function, and, in that regard, this description is intended to be general. It is thought, however, that a three-armed device may be simple to construct.

The apparatus described herein may be used to open or close a door or drawer automatically by the use of actuators. In the first embodiment the mechanism is used to open swing doors, such as might be kitchen cabinet doors. In the second embodiment, the sliding mechanism may be used in kitchen cabinet drawers. However, either or both mechanisms might also be used in similar application such as dresser drawers, closets, and so on. Each of the mechanism may use a single 6V or 12V DC motor to generate the force.

One type of mechanism is designed for a swinging door, such as a cupboard door. Another type is designed for sliding drawers. For a swinging door mechanism, a rotational motion is generated by a bi-directional servo motor to open or close, or open and close, the door. On a sliding mechanism, rotational motion of a geared motor may be converted to translational motion to slide the drawer in or out. These motors are controlled by a microcontroller as one system or individual unit with IR motion sensor integration or remotely via Wi-Fi or Bluetooth or voice control. In some embodiments the mechanisms may be operated by 6V or 12V DC battery adapter.

The automatic mechanisms shown and described herein may be triggered by a switch, by motion sensors or by a voice command. In the first embodiment, the swinging door mechanism includes a retractable key mechanism, spring-biased arm 90 and cam follower 98 mounted on the servo. Once an open command is received, motor 44 will turn 180 degrees (more or less) and push the lever pin on its way by this key to open the door. Similarly, when motor 44 turns in the opposite direction, it urges the door to close.

In the second embodiment, the drive transmission is set underneath the drawer. The rotatable anchor mechanism is permanently attached to drawer with the rotatable three-armed members. The hook is mounted on the timing belt drive. The timing belt is driven by the 6/12V motor 150. When the apparatus receives a command to open, motor 150 drives the hook forward, encountering and snagging the anchor on its way to pull the drawer open. At the destination, the flip gear (located beside the anchor on the keyed shaft in the illustrations) will hit a stop bar, be it 162 or 164. The stop bar turns the flip gear to make the hook release the anchor, and then stop. Similarly, when the motor turns opposite direction, it brings the drawer in toward the closed position.

The various embodiments may include one or more of the automatic cabinet openers that have individual mechanism as showing in the first embodiment of FIGS. 1a-4b in which the driven link reciprocates along the same path in both opening and closing, and the same configuration of lever is used for both actions, i.e., the lever plate, or driven link, has the same style or configuration to push the door open or to bring the door to a closed position. The retractable engagement key defined by lever arm 90 working in slot 94. This single slide-retractable engagement key of a single style, shape or configuration is used to push the driven link in both directions, and disengages in the “at rest” position at either end of the stroke. The first embodiment also employs the same design of top and bottom plates as guides for the lever pin of the driven member.

In the slide drawer embodiments, the mechanism has a jaw anchor, and a jaw flip gear that have substantially the same configuration (three armed) and that are located beneath the drawer. In that same embodiment there is the arrangement of a hook mounted on a timing belt, the belt being a reciprocating belt, that is mounted to slide or translate back and forth underneath the drawer or the space envelope in which the drawer is constrained to move. This embodiment may also include a hook, or ring, or eye, mounted to engage with the three-jawed anchor, and, when so engaged, to slide the drawer in and out, and that disengages in the at-rest position at either end of the travel stroke. This embodiment also includes the feature of self-disengagement of the hook from the anchor jaw (or jaws) at the “at rest” position when the apparatus encounters the stop key blocks, i.e., the finger abutments. The embodiment includes, or may include, the features of the drawer assembly generally as shown and described.

In any case, whichever embodiment is employed, the cabinet or drawer opener may includes the opening actuator having or being is a 4V to 12V DC electronic servo motor for the swinging door mechanism or a 6 V to 24V DC geared motor on drawer slide mechanism. In an alternative, the system may be operated by using as a power source a set of 3V to 15V rechargeable DC batteries.

A further feature of these apparatus may include a single integrated system that may be controlled by a microcontroller with IR motion or touch sensor, or by voice control, Human Machine Interface, staples, Ipad, Ipod, or other smart phone devices and so on. In another feature, the mechanisms can be separated into individual standalone units with standalone controller boards and infrared motion or touch sensors. In another feature, the cabinet openers are designed to be the add-on, or retro-fit, devices for mounting to or in existing home kitchen cabinets or drawers (or manufactory integrated) to offer a hands-free option. In some embodiments, the mechanisms, e.g., the doors or drawers, may offer, optionally, both manual and automatic operation.

The various embodiments described herein may be supplied as part of the original equipment of a set of cabinets or a set of drawers. If cabinets are ordered in advance, for example, they may come with the apparatus installed. However, they may also be supplied for retro-fit installation, and, when so supplied, it may be that the mounting fittings are mounted by tape of other adhesive or bonding technique such as may tend not to cause permanent damage to the underlying structure, as mechanical fasteners such as screws or nails might otherwise do.

What has been described above has been intended illustrative and non-limiting and it will be understood by persons skilled in the art that other variances and modifications may be made without departing from the scope of the disclosure as defined in the claims appended hereto. Various embodiments of the invention have been described in detail. Since changes in and or additions to the above-described best mode may be made without departing from the nature, spirit or scope of the invention, the invention is not to be limited to those details but only by the appended claims.

I claim:

1. An enclosure access apparatus mountable to drive a movable enclosure member relative to a stationary enclosure member, said apparatus comprising:
at least one fitting by which manually to move the movable enclosure member relative to the stationary enclosure member;
an automated drive transmission also connected to move the movable enclosure member relative to the stationary enclosure member;
at least a first user input, said first input being user-activated, said drive transmission being connected to operate upon receipt of a signal from said first input;
said drive transmission having a first mode of operation to urge said movable enclosure member to move along a path of reciprocation relative to the stationary enclosure member;
said drive transmission having a second mode of operation to urge said movable enclosure member to return along said path of reciprocation relative to the stationary enclosure member; and
said drive transmission having a disengaged mode when not activated, in said disengaged mode said drive transmission remaining passive when said movable enclosure member is moved manually by said at least one fitting.

2. The apparatus of claim 1 wherein said apparatus includes a manual over-ride, and, in a condition of manual over-ride, said automated drive transmission having a self-disengagement mode.

3. The apparatus of claim 1 wherein said apparatus includes a touchless actuation sensor.

4. The apparatus of claim 3 wherein said touchless actuation sensor includes at least one of (a) a capacitance sensor; (b) an optical sensor; and (c) a voice-activated sensor.

5. The apparatus of claim 3 wherein said apparatus includes a plurality of touchless actuation sensors, and said apparatus operates in response to actuation of any one of said touchless sensors.

6. The apparatus of claim 3 wherein said apparatus has at least one said touchless sensor and at least one contact operated input.

7. The apparatus of claim 6 wherein said at least one contact operated input includes at least one of (a) a push button; (b) a wall switch; and (c) a treadle.

8. The apparatus of claims 1 wherein said apparatus includes a four-bar linkage.

9. The apparatus of claim 8 wherein said drive transmission is self-disengageably connected to move said four bar linkage.

10. The apparatus of claim 1 wherein the movable enclosure member is a hingedly mounted door, and the apparatus includes a motor and a drive link; the drive link is formed to have an accommodation therein; and, in at least one position of the apparatus said drive link nests about said motor.

11. The apparatus of claim 10 wherein said motor is a DC one of a servo motor and a geared motor.

12. The apparatus of claim 1 wherein the movable enclosure member is a drawer, and said apparatus includes a timing belt drive operable to open and close the drawer.

13. The apparatus of claim 1 wherein said apparatus has a range of travel of said drive transmission, said range of travel having first and second ends, at least one of said first and second ends includes an “at rest” position; and said disengaged mode includes said drive transmission being in one said “at rest” position.

14. The apparatus of claim 1 wherein said apparatus is a hinged-door moving apparatus, said apparatus includes a pair of spaced apart plates co-operatively defining a circumferential arc about an axis of rotation of an output shaft driven by a motor, said transmission includes a driven link has a first end and a second end, said first end of said driven link is constrained to follow said circumferential arc, and, in at least one position of said hinged door said driven link nests between said spaced apart plates, and said driven link has a bent shape to seat about output shaft.

15. The apparatus of claim 1 wherein said drive transmission includes a motor-driven output arm and a driven link; said motor is drivable alternately clockwise and counterclockwise; said output arm is disengageable from said output link; and, said output arm engages a first portion of said driven link when said motor is operating to drive the movable enclosure member in a first direction, and said output arm engages a second portion of said driven link when said motor is operating to drive the movable enclosure member in a second direction opposite to the first direction.

16. The apparatus of claim 15 wherein one of said output arm and said driven member has a cam and the other has a cam follower, and one of said cam and said cam follower is displaceable against a bias to permit disengagement from the other.

17. The apparatus of claim 1, the movable enclosure member being a drawer, and wherein said drive transmission includes a first member mounted to a motor-driven belt, and a second member mounted to the drawer;
one of the first and second members is a lug;
the other of the first and second members is a catch for mating operation with the lug;
the catch includes a multi-armed pivotable anchor;
the pivotable anchor is positioned to encounter, to be deflected, and to snag the lug during relative motion of the lug past the anchor; and
said apparatus includes at least one disengagement member positioned to encounter said anchor to release said anchor from said lug.

18. The apparatus of claim 1 wherein said apparatus is an automatic kitchen cabinet opener, and the mechanisms can be grouped into one system to be controlled by a microcontroller with any one of IR motion sensors, touch sensors, voice control, a Human Machine Interface, staples, Ipad, Ipod, or other smart phone devices.

19. The apparatus of claim 1 wherein said apparatus is separated into individual standalone units with standalone controller boards and infrared motion/touch sensors.

20. The apparatus of claim 1 wherein said apparatus is provided as a retro-fit add-on kit for mounting to existing home kitchen cabinets/drawers as a hands-free mechanism permitting both automatic and manual operation modes.

21. The apparatus of claim 1 wherein said apparatus is mounted to at least one of (a) said stationary enclosure member; and (b) said movable enclosure member, exclusively by non-destructive attachment, where said non-destructive attachment includes one of (i) a bonding agent; (ii) an adhesive tape; and (iii) a glue.

22. The apparatus of claim 1 wherein said apparatus includes a power source, and said power source includes a set of rechargeable batteries, said set of batteries having a voltage range of 3V DC to 15 V DC.
